(19) United States
(12) Patent Application Publication
(10) Pub. No.: US 2021/0187773 A1
(43) Pub. Date: Jun. 24, 2021

(54) METHOD AND SYSTEM TO CONTROL, AUTOMATE, MONITOR, AND SHUT DOWN A DELI SLICER

(71) Applicant: HOLLYMATIC CORPORATION, Countryside, IL (US)

(72) Inventors: Victor GUYNN, Romeoville, IL (US); David BAARMAN, Fennville, MI (US)

(73) Assignee: HOLLYMATIC CORPORATION, Countryside, IL (US)

(21) Appl. No.: 17/058,255

(22) PCT Filed: May 30, 2019
(86) PCT No.: PCT/US19/34541

§ 371 Date: Nov. 24, 2020

Related U.S. Application Data
(60) Provisional application No. 62/678,334, filed on May 31, 2018.

(51) Int. Cl. B26D 7/22; H01F 7/08; B26D 1/153; B26D 5/08; B26D 7/32

(52) U.S. Cl. CPC B26D 7/225; H01F 7/08; B26D 2210/02; B26D 5/086; B26D 7/32; B26D 1/153

(57) ABSTRACT

A system and method relating to a slicer system, the slicer system includes a slicer that includes a slider blade, a first motor configured to rotate the slicer blade, an in-feed table configured to hold the product and move, while the product is sliced by the slicer blade; an out-feed table configured to receive a sliced portion of a product, in response to the slicer blade slicing the product, at least one second motor, each of the at least one second motor configured to move the out-feed table in at least one direction; and at least one processor configured to cause the sliced portion of the product to be received on the out-feed table in a predetermined shape by controlling the at least one second motor to move the out-feed table while the slicer is slicing the product.

### RELATED APPLICATIONS

The present application claims priority to U.S. Provisional Application No. 62/678,334, filed on May 31, 2018, the contents of which are incorporated herein by reference in their entirety. The entire contents of U.S. non-provisional application Ser. No. 15/906,402, filed Feb. 27, 2018, and U.S. non-provisional application Ser. No. 16/260,512, filed Jan. 29, 2019, are incorporated herein by reference.

### BACKGROUND

### Technical Field

Some embodiments of the present disclosure relate to systems, methods, and apparatuses for automatically cutting products, stopping cutting equipment, and monitoring a blade that may come in contact with human body parts.

### Description of Related Art

Systems in a related art may comprise methods such as detecting the resistance of skin and mechanically thrusting the blade of a slicer into a nylon barrier, which in turn stops the blade. The mechanical grabbing of the blade either damages the blade or destroys the blade and this may be undesirable. Other systems may use cameras as a visual means to detect the presence of an operator. Another system may utilize a conductive method and skin resistance. It should be noted that cutting conductive materials creates issues for these systems discussed above.

Conductive materials like aluminum or meat eliminates raises issues requiring special provisions and consideration. U.S. Pat. No. 7,924,164 B1 shows an example of a visual system that monitors a body part and a zone triggering a shut down event. Although the visual system may be helpful for training and tracking proximity, it has use and resolution limitations in a dirty environment where gloves, cameras, and equipment can become covered in blood, meat, and liquids. It should also be noted that with fast moving parts and actions, reaction times for vision systems present a challenging issue.

In a related art system, some slicers may grab the blade mechanically and cause damage to the blade.

In related art deli slicers, an entry point of the deli slicers included a large exposed blade and a sliding guide. The slicing of a deli slice to be a specified thickness and the process of catching slices and folding slices was manually accomplished by a user. With such related art deli slicers, a user also had to guess the weight of a deli slice(s), and add more or less based on trial and error.

Some known problems of the related art technologies relate to the precision of movement required by the user. When using a related art slicer, a user must perform a specific set of slicing movements, requiring feel and feed speeds, and must perform catching of the deli slice in a way that presents the product in the way the customer may want to display, store, or utilize.

Other issues with related art technologies include the inability to automate the complete process, and issues with infeed, outfeed, weight, and safety.

### SUMMARY

The present disclosure addresses several matters such as those described above, and other matters not described above. Embodiments of the present disclosure may be considered key solutions to past problems that have been observed and modified for better results in the production environment.

Some embodiment of the present disclosure enable a faster and more reliable slicer system. Past solutions are not designed for automated processing and typically are not designed for production processing. Automated slicer system embodiments of the present disclosure enable faster production and more controlled presentation of sliced products for better customer satisfaction. In an embodiment, a slicer system does not mechanically grab the blade, thus there is no damage to the blade. In an embodiment, resetting the slicer after hard stop takes only 5 seconds to restart. In an embodiment, a sliced product may be automatically stacked and folded with precision to a programmed weight. Some embodiments of the present disclosure also include a magnetic interlock device. Just by walking up to the device, the user may be connected to the slicer. Users may interface with the slicer for loading, programming, and unloading. Embodiments of the present disclosure may allow users time to do other things as the slicer is cutting. In an embodiment, a guard may be automatically enabled when a connection between the user and the magnetic interlock is broken. Embodiments of the present disclosure may automate slicing while protecting the blade from user interface.

In an embodiment, a slicer system comprises a slicer. The slicer comprises a slicer blade configured for slicing a product; a first motor configured to rotate the slicer blade; an in-feed table configured to hold the product and move, while the product is sliced by the slicer blade; an out-feed table configured to receive a sliced portion of the product, in response to the slicer blade slicing the product; at least one second motor, each of the at least one second motor configured to move the out-feed table in at least one direction; and at least one processor configured to cause the sliced portion of the product to be received on the out-feed table in a predetermined shape by controlling the at least one second motor to move the out-feed table while the slicer is slicing the product.

In an embodiment, the slicer further comprises: a guard configured to cover the slicer blade; and a third motor configured to move the guard between a first position in which the guard covers the slicer blade from an outside and a second position in which slicer blade is unguarded by the guard, wherein the at least one processor is configured to control the third motor to move the guard.

In an embodiment, the at least one processor is configured to cause the guard to be in the second position in response to a slicing operation of the slicer blade being completed.

In an embodiment, the in-feed table is configured to be manually moved by a user, the at least one processor is further configured to: receive a user command to operate the slicer in a manual mode, and keep, while the slicer is operating in the manual mode, the guard in the second position, while the user is manually moving the in-feed table to cut the product.

In an embodiment, the slicer system further comprises a user-worn device. The user-worn device comprises at least one magnet; a conductive path; and at least one processor configured to send a signal through the conductive path, wherein the slicer comprises an interface including at least one magnet and a conductive path, the at least one magnet of the interface being configured to magnetically engage with the at least one magnet of the user-worn device, such that the conductive path of the user-worn device is electrically connected to the conductive path of the slicer, and the at least one processor of the slicer is configured to move the guard into the first position or the second position in response to receiving a specified signal from the conductive path of the user-worn device.

In an embodiment, the slicer is configured to move the guard into the second position in response to receiving the specified signal from the conductive path of the user-worn device.

In an embodiment, the user-worn device further comprises at least one processor configured to send the specified signal to the conductive path of the slicer, via the conductive path of the user-worn device.

In an embodiment, the at least one magnet of the user-worn device is configured to extend and retract from a body of the user-worn device while magnetically engaged with the at least one magnet of the interface of the slicer.

### BRIEF DESCRIPTION OF DRAWINGS

A brief description of some representative drawings is provided as follows.

FIG. 1 illustrates a front view of a slicer of an embodiment;

FIG. 2 illustrates a side view of the slicer of FIG. 1;

FIG. 3 illustrates a diagram showing examples of how meat may be automatically folded on an out-feed table of the slicer of FIG. 1;

FIG. 4 illustrates a lowered position of a guard of the slicer of FIG. 1;

FIG. 5 illustrates a raised position of a guard of the slicer of FIG. 1;

FIG. 6 illustrates a slicer system of an embodiment;

FIG. 7 illustrates a user interface of an embodiment;

FIG. 8 illustrates an embodiment of a glove system that comprises a device that may mount on, for example, a belt of a user, and allows the user connection to a slicer;

FIG. 9 illustrates a metal detection system of an embodiment;

FIG. 10 illustrates a vision system of a slicer system;

FIG. 11 illustrates gloves of a slicer system;

FIG. 12A illustrates a first part of a startup process of a manual mode of an embodiment for checking all systems before starting a slicer;

FIG. 12B illustrates a second part of the startup process of the manual mode of an embodiment for checking all systems before starting the slicer;

FIG. 13A illustrates a process monitoring loop of an embodiment when a slicer is running in a manual mode;

FIG. 13B illustrates a process monitoring loop of another embodiment when the slicer is running in a manual mode;

FIG. 13C illustrates a process monitoring loop of another embodiment when the slicer is running in a manual mode;

FIG. 14 illustrates information of zones and performance that may be recorded by a slicer system for performance and safety rating purposes;

FIG. 15 illustrates information of zones and performance that may be recorded by a slicer system for performance and safety rating purposes;

FIG. 16 illustrates a data tracking method of a slicer system;

FIG. 17 illustrates an embodiment in which a slicer has connectivity; and

FIG. 18 illustrates an embodiment of a dynamic brake of a saw.

### DESCRIPTION OF EMBODIMENTS

In a slicer system embodiment, the slicer system may include two sets of gloves. The first set of gloves may keep the hands warm and dry, and also may be conductive and act as electrodes. The slicer system may verify a user by measuring an impedance between the two gloves in response to receiving a signal from the gloves, thus verifying to the slicer that the user is present and the gloves are connected. The user may also be verified by the slicer receiving contact ID from a device of a glove system, which includes the gloves. The device may send an ID code to the slicer, and the slicer may be connected to a database, such as a database in a cloud computing environment. User statistics, processing speed, and safety statistics may be retained and measured over time by the slicer system. The body impedance of a user can be used to recognize specific people for characterization. Then, an identification code may be sent electronically or optically from a glove system to the slicer, when connected to the slicer. Safety systems, such as a glove system, camera system, and metal detection system, may be provided with an automated slicer system that enables automatic slicing operations and safety guard(s) use. The safety guard use may be automatic in situations such as loading and programming a slicer, and slicing with the slicer. Embodiments of the present disclosure may allow safe, unmonitored use of the slicer by assuring the guard is in place when the interlock is broken or disabled. This assures safe operation for the user and safe automated operation. With saw systems of embodiments of the present disclosure, complex movements required for artistic presentation of the sliced product can be completely automated, programmable, and reproducible. When a slicing operation is complete, the slicer may automatically stop and the guard may automatically open for unloading and reloading.

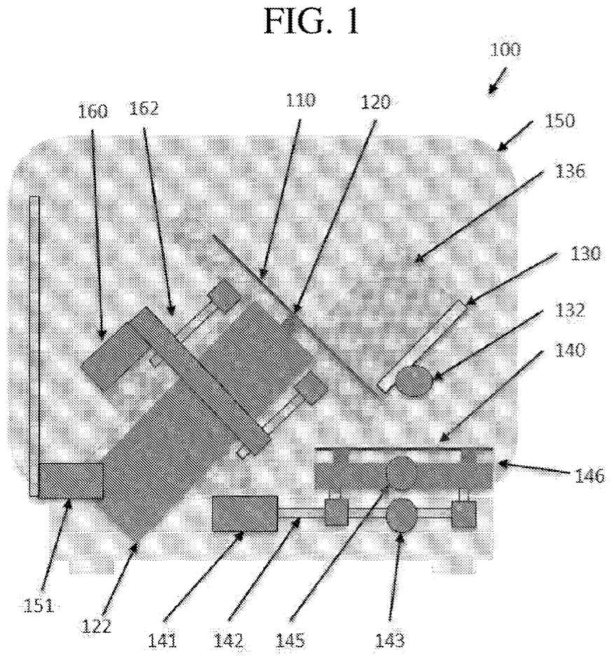

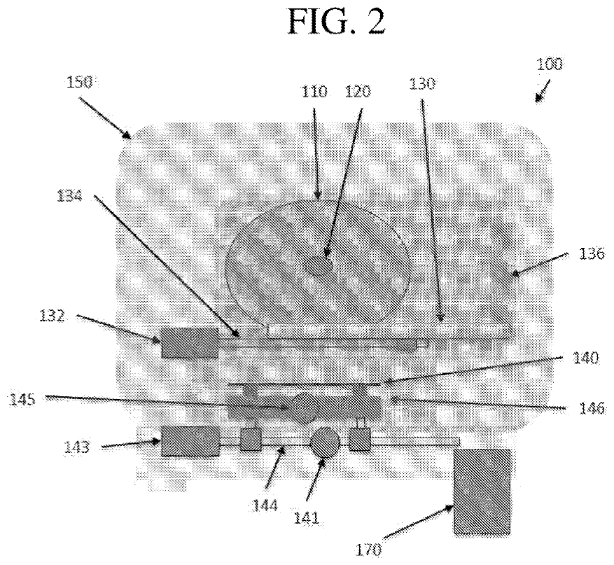

FIGS. 1 and 2 illustrate views of a slicer 100 of an embodiment. The slicer may be automated and may be, for example, a deli slicer for slicing products such as meat. The slicer 100 may include, for example, a blade 110, a shaft 120, a blade motor 122, an in-feed table 130, an out-feed table 140, an in-feed table motor 132, a screw 134, an in-feed table stop 136, an X-axis motor 141, an X-axis screw 142, a Y-axis motor 143, a Y-axis screw 144, a Z-axis motor 145, a Z-axis screw (not shown), load cells 146, a guard 150, a guard lift mechanism 152, a table depth adjustment motor 160, belt driven ball screws 162, and a safety interlock 170.

The blade 110 may be a circular blade. In an embodiment, the blade 110 may weigh about 5 lbs. The blade 110 may be connected to the blade motor 122, via the shaft 120, and the blade motor 122 may cause the shaft 120 and the blade 110 to rotate to perform a slicing operation. The blade motor 122 may include a brake that causes the shaft 120 and the blade 110 to stop rotating. To reduce inertia and weight, the blade motor 122 may be direct driven with the shaft 120, wherein the shaft 120 is short.

The in-feed table 130 may be located adjacent to the blade 110 and hold product, such as meat, to be sliced by the blade 110. The in-feed table 130 may include an in-feed table stop 136 that assists in holding the product. The in-feed table 130 may be connected to an in-feed table motor 132 that is configured to cause the in-feed table 130 to move relative to the blade 110 such that product on the in-feed table 130 is sliced by the blade 110. For example, the in-feed table motor 132 may be configured to cause the in-feed table 130 to move linearly in left-right directions, with respect to the view of FIG. 2, such that product moves into and away from a cutting edge of the blade 110. The in-feed table motor 132 may be, for example, a linear actuator such as a ball screw motor. In an embodiment, the in-feed table motor 132 may be connected to, for example, a screw 134 that is connected to the in-feed table 130. The in-feed table motor 132 may move the in-feed table 130 by causing a linear movement of the screw 134.

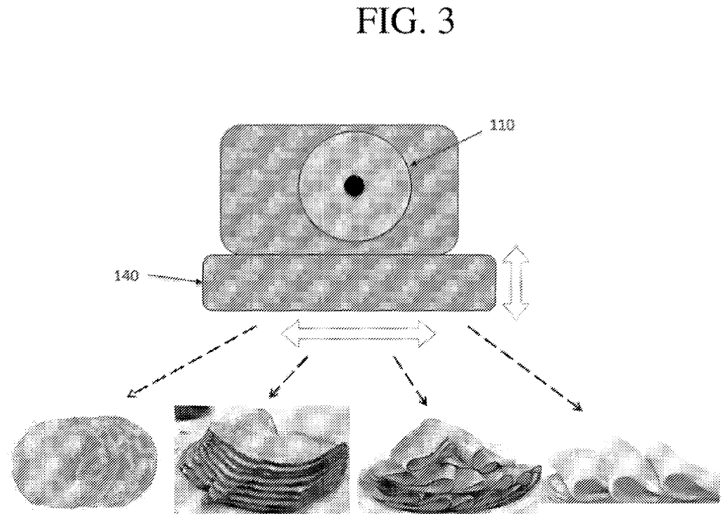

The out-feed table 140 may be located below the blade 110 and the in-feed table 130, such that product cut by the blade 110 is collected on the out-feed table 140. The out-feed table 140 may be moved in various directions by at least one motor. For example, the slicer 100 may include an x-axis motor 141, a y-axis motor 143, and a z-axis motor 145 that are configured to move the out-feed table 140 in x directions (left-right with reference to FIG. 1), y-directions (in-out of the page, with reference to FIG. 1), and z-directions (up-down, with reference to FIG. 1), respectively. Each of the motors may be, for example, a linear actuator such as a ball screw motor. In an embodiment, the x-axis motor 141 and the y-axis motor 143 may be connected to an x-axis screw 142 and a y-axis screw 144, respectively, that are connected to the out-feed table 140. Also, the z-axis motor 145 may be connected to a z-axis screw (not shown) that is connected to the out-feed table 140. The motors may each move the out-feed table 140 by causing a linear movement of the screw in which the motors are respectively connected to. In an embodiment, the slicer 100 may alternatively or additionally include at least one motor that causes the out-feed table to rotate. Because the out-feed table 140 may be controlled to move via the motors, the out-feed table 140 may automatically and precisely cause stacking and folding of product on the out-feed table 140, after the product is sliced by the blade 110. For example, product may be stacked as illustrated in FIG. 3.

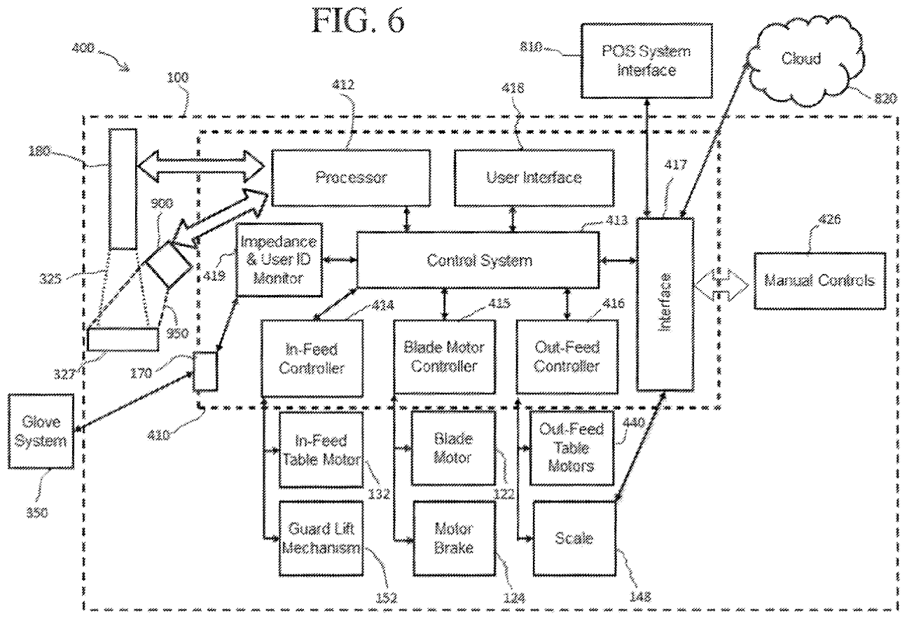

The out-feed table 140 may include load cells 146 that are configured to detect a load on a top of the out-feed table 140. For example, the load cells 146 may be connected to a scale 148 illustrated in FIG. 6, and may send an input signal to the scale 148 that corresponds with a load force on the out-feed table 140. The scale 148 may determine the load force based on the input signal. Accordingly, the scale 148 with the load cells 146 may detect a weight of sliced product on the out-feed table 140.

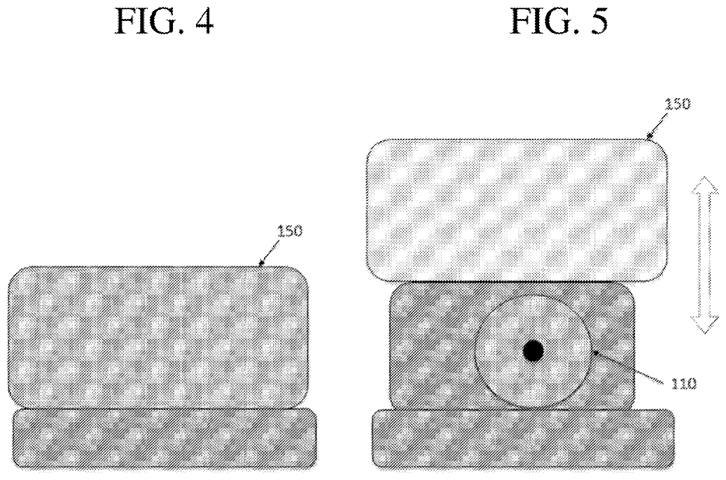

The guard 150 may be configured to surround the blade 110 such as to protect a user from the blade 110. In an embodiment, the guard 150 may also be configured to surround the in-feed table 130 and the out-feed table 140. The guard lift mechanism 152 may include a motor and may be configured to automatically move the guard 150 into a guarding position and a non-guarding position. With reference to FIGS. 4-5, the guard lift mechanism 152 may move the guard 150 upwards and downwards such that the blade 110 is not guarded and guarded, respectively. When the guard 150 is not guarding the blade 110, a user may load and reload the slicer 100 with product for cutting. In embodiments, when the guard 150 is not guarding the blade 110, a user may perform manual cutting with the slicer 100. For example, the user may manually move the in-feed table 130 to cause the blade 110 to cut product. In embodiments, when the guard 150 is guarding the blade 110, the slicer 100 may operate in an automatic mode where product is automatically cut and folded by the slicer 100.

The safety interlock 170 may connect with a user-worn system and be an aspect of a safety system. In an embodiment, the safety interlock 170 may be, for example, a magnetic interlock. Also, the safety interlock may be provided at various heights, including belt heights of users. In an embodiment, when a user walks up to the slicer 100 and gets his/her belt close to the safety interlock 170, the user-worn system and the safety interlock 170 may magnetically engage such that a conductor pathway for communication is provided between the user-worn device and the slicer 100. For example, the safety interlock 170 may include a set of strong magnets, such as a rare earth magnets, connected to sensor wires, while a waist mounted portion of the user-worn system includes a corresponding set of strong magnets to enable magnetic attraction between the safety interlock 170 and the waist mounted portion of the user-worn device. The poles of the magnets in the safety interlock 170 and the waist mounted portion of the user-worn system may be oriented such that the safety interlock 170 and the user-worn system only connect in a specified orientation, relative to each other. Example embodiments of a user-worn system are described further below.

FIG. 6 illustrates an embodiment of a slicer system 400 that includes safety systems and enables automated and manual modes of operating the slicer 100.

The slicer system 400 comprises, for example, the slicer 100, a Point of Sale (POS) system and interface 810, a cloud computer environment 820, and a user-worn system such as, for example, glove system 350 associated with a user. The slicer 100 may comprise a slicer monitor system 410 that includes a processor 412, a control system 413, an in-feed controller 414, a slicer motor controller 415, an out-feed controller 416, an interface 417, a user interface 418, an impedance & user ID monitor 419, and a safety interlock 170. The slicer 100 may further comprises the in-feed table motor 132, the guard lifting mechanism 152, the blade motor 122, a motor brake 124, out-feed motors 440, and the scale 148.

The processor 412, the control system 413, the impedance & user ID monitor 419, the in-feed controller 414, the blade motor controller 415, the out-feed controller 416, and the scale 148 may together or separately be formed of at least one computer processor and memory. The slicer 100 may also comprise, for example, a metal detection system 900, a camera 180, and manual controls 426.

The in-feed controller 414 and the out-feed controller 416 may control the in-feed table motor 132 and the out-feed table motors 440 (e.g. x-axis motor 141, y-axis motor 143, and z-axis motor 145), respectively, to drive a movement of the in-feed table 130 and the out-feed table 140, respectively. The in-feed controller 414 may also control the guard lift mechanism 152 to lower or raise the guard 150. Alternatively, the guard lift mechanism 152 may be controlled by a separate controller. The blade motor controller 415 may control the blade motor 122 to drive a rotation of the blade 110, and may control the motor brake 124 to brake the blade motor 122, thereby causing the blade 110 to slow and stop. The out-feed controller 416 may also be connected to the scale 148.

The control system 413 may function to receive the various input signals, including sensor data and command inputs, to determine how the blade 110, in-feed table 130, out-feed table 140, and guard 150 is to be operated based on the input signals, and cause the blade motor controller 415, the in-feed controller 414, and the out-feed controller 416 to control the motors and the guard lift mechanism 152 in the determined manner. The control system 413 may also control other moving components of the slicer 100. The sensor data may be provided to the control system 413 by, for example, the metal detection system 900 and the camera 180 via the processor 412, the glove system 350 via the impedance & user ID monitor 419, the in-feed controller 414, the blade motor controller 415, the out-feed controller 416, and the scale 148. Command inputs may be provided to the control system 413 by, for example, the user interface 418, the cloud computing environment 820, and the manual controls 426.

In an embodiment, the control system 413 may be connected to the processor 412, interface 417, and the impedance & user ID monitor 419 to determine whether the slicer 100 should start or stop operation, based on inputs of the metal detection system 900, the camera 180, the glove system 350, and sensors and controls connected to the interface 417.

The glove system 350 may be connected to the slicer 100, via the safety interlock 170, to supply user ID, glove status inputs, and other information to the impedance & user ID monitor 419. In an embodiment, when a user walks up to the slicer and gets his/her belt close to the safety interlock 419, the glove system 350 and the safety interlock 170 may magnetically engage such that a conductor pathway for communication is provided between the glove system 350 and the slicer 100. The impedance & user ID monitor 419 may determine the identity of a user that uses the glove system 350, based on the supplied user ID or other information supplied by the glove system 350 that indicates a user ID, and may further determine a state of gloves based on glove status inputs supplied from the glove system 350, including conductivity values. For example, the impedance & user ID monitor 419 may measure the impedance across the body of a user as an additional check to the safety interlock 170.

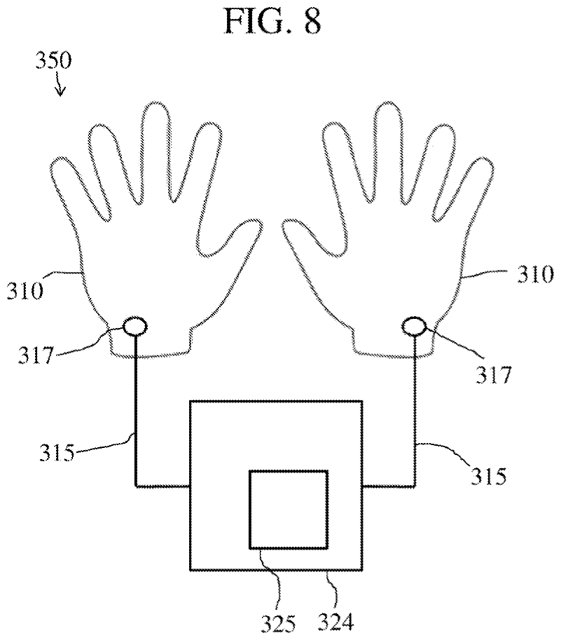

In an embodiment, to improve safety and tracking, the slicer system 400 may also detect whether a user touches the blade 110 with gloves 310 of the glove system 350 (illustrated in FIG. 8) or moves a glove 310 too close to the blade 110. For example, the slicer system 400 may include metal detection systems and camera vision systems. In such embodiments, the control system 413 may cause the blade 110 to stop rotating and cause the guard 150 to lower when the user is too close to the blade 110.

For example, the metal detection system 900 of the slicer 100 may supply an input signal, such as sensor data, to the processor 412 to determine whether a glove 310 of the glove system 350 is detected in an entryway of the blade 110. The processor 412 may also detect whether the metal detection system 900 is faulted.

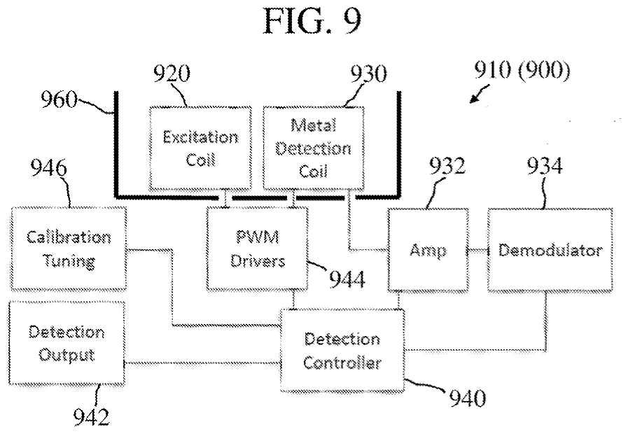

It is noted that, while the metal detection system 900 is shown to be above a detection area of the slicer 100 and focused on a training zone 327, the metal detection system 900 may be at any location and have a detection area 950 of any angle and focus, with respect to the slicer 100, so long as the metal detection system 900 is positioned to detect a position of a user before the user touches the blade 110. For example, the metal detection system 900 may be below, above, or on a side of the blade 110. Also, the metal detection system 900 may be configured to have a detection area 950 that is away, toward, or parallel to the blade 110. The metal detection system 900 may also include a plurality of sensing devices, such as detectors 910 (illustrated in FIG. 9), that each include, for example, at least one coil for metal detection. The plurality of sensing devices may be positioned around the blade 110 at varying positions and angles to increase the locations in which a user is detected when they are too close to the blade 110.

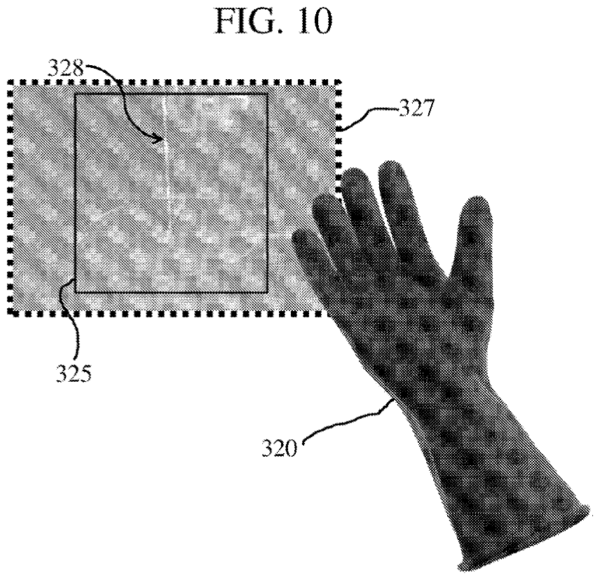

Alternatively or additionally, a camera 180 may be included with the slicer 100 and may supply image data to the processor 412, the image data may include images in which the gloves 320 (as illustrated in FIG. 10), the safety zone 325, the training zone 327, and an optical barcode corresponding to a user ID are captured. The processor 412 may determine an identity of a user of the glove system 350 based on detection of an optical barcode provided on gloves 320 of a glove system. The processor 412 may also determine whether the image data includes a visual cue that suggests a safety issue with respect to a user of the glove system in their use of the slicer 100. For example, the processor 412 may determine whether one of the gloves 330 enters within the safety zone 325. The processor 412 may also detect whether the camera 180 is covered or faulted. The processor 412 and the camera 180 may together be an ultra-high speed vision system wherein the processor 412 has a total processing and output time of, for example, around 0.014 s and a buffered output in case a scan misses closing a relay to give a stop signal. Accordingly, unlike other vision sensors and systems tested, the ultra-high speed vision system can cause the slicer 100 to stop even when an object sensed by the camera 180 is moving fast.

The processor 412 may be a plurality of processors. For example, the processor 412 may include at least one processor that performs the functions of the processor 412 that are related to the camera 180, and may further include at least one processor that performs the functions of the processor 412 that are related to the metal detection system 900.

The interface 417 may function as a communication interface between components of the slicer system 400, such as the control system 413, and computing devices, including local computing devices via wired and wireless local networks, and a cloud computing environment 820 via the internet. The interface 417 may also be wired or wirelessly connected to a POS system interface 810 and manual controls 426, and also be connected to the scale 148. The manual controls 426 may include, for example, start and stop buttons and emergency stop buttons. The POS system and interface 810 may be at least one computer, comprising at least processor, directly or indirectly connected to the slicer 100 for printing price tags and content labels as well as tracking product types and weight sold. The POS system and interface 810 may have barcode or other product tracking systems for determining the product type and cost. In such an embodiment, the slicer system 400 may identify inventory and track usage and consumption in near-real time.

The slicer system 400 may be operated in manual and automatic modes.

In an embodiment, a manual mode may be a mode where the guard 150 is automatically raised or lowered depending on whether the glove system 350 is connected to the slicer 100, via the safety interlock 170. For example, the guard 150 may be automatically raised when the glove system 350 and the safety interlock 170 magnetically engage and the impedance & user ID monitor 419 determines that a user is wearing the gloves 330. Accordingly, a user wearing the gloves 330 that are connected to the safety interlock 170 may perform a manual cutting process with the slicer 100, load the slicer 100 with product, or unload product from the slicer 100. In the manual mode, the guard 150 may automatically lower if the slicer system 400 determines that the glove system 350 is disconnected from the safety interlock 170, the glove system 350 is faulted, or if there is a detected safety concern such as when the slicer system 400 detects that a user touches the blade 110 with a glove 330 of the glove system 350 or moves a glove 330 too close to the blade 110. When a condition occurs that causes the guard 150 to lower, the slicer system 400 may also control the blade to stop. By lowering the guard 150 at times when a hazard is about to occur or when a stop condition is enabled, and keeping the guard 150 lowered before the slicer 100 is operated, injuries to a user caused by the blade 110 may be better avoided, including injuries that occur when a deli slicer is stopped in preparation for a job.

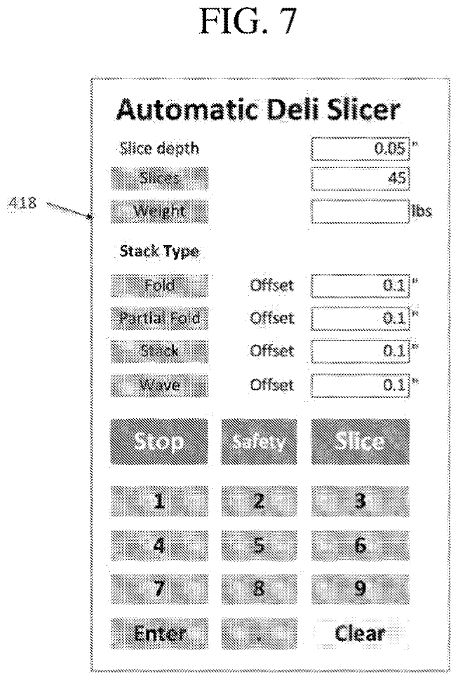

In an embodiment, the automatic mode may be a mode wherein the slicer system 400 keeps the guard 150 in a lowered position, to protect the blade 110, while the slicer 100 performs an automatic slicing process. The automatic slicing process may include the control system 413 controlling the blade motor 122, the in-feed table motor 132, and the out-feed table motors 440 in a manner to form a sliced product having specified characteristics including, for example, a specified weight, slice thickness, and stacking shape. Specified characteristics for the automatic mode may be selected by a user via the user interface 148. The user interface 148 may be provided on a display of a display device, such as PC, mobile device, or tablet. As illustrated in FIG. 7, the user interface 418 may allow a user to specify characteristics such a weight, slices, slice thickness, stacking parameters, and offsets. The user interface 418 may also indicate whether the safety interlock 170 is engaged with the glove system 350, and may enable a user to select an automatic and manual operation of the slicer 100.

Before or following a slicing process, the guard 150 may be controlled to be in a raised position to allow a user to load the slicer 100 with product, or unload product from the slicer 100.

With reference to FIG. 8, embodiments of the glove system, that may be used as a user-worn system, are described.

A slicer system of at least one embodiment of the present disclosure may only require conductive gloves, colored rubber gloves, or colored rubber gloves over conductive gloves. In contrast, other slicers may require an operator to use several pairs of gloves and new boots with no holes, and for the operator to have no perspiration or moisture in their clothing. Further, other slicers may require the operator to stand on a grate to isolate themselves from any grounding, due to the whole body sensing of an electrode being used.

With reference to FIG. 8, the glove system 350 may be an impedance detection glove system that may be used in discerning the present impedance of a human or meat is described.

In the slicer 100, an input signal from the glove system 350 to the slicer 100, via the safety interlock 170, may be caused by the closure of an electrical circuit due to physically touching the blade 110, which is metallic, with at least one of electrically conductive gloves 310. The electrically conductive gloves 310 may comprise interwoven conductive fibers. As illustrated in FIG. 8, the gloves 310 may be connected to a tether 315 via a conductor 317, wherein the tether 315 is attached to a connector block 324 that is mounted on a user's clothing (for example, a belt).

The connector block 324 may include at least one processor and memory. The processor of the connector block 324 may output a user ID, glove status inputs, and other information to a slicer, such as the slicer 100 via a connection of the connector block 324 to the safety interlock 170. The memory of the connector block 324 may store the user ID, glove status inputs, and the other information. The connector block 324 may alternatively or additionally be configured as a moving spring wound retractable block, such that a portion of the connector block 324, is an extendable portion 325 that may extend or retract. The extendable portion 325 may include magnets for magnetic connection to the safety interlock 170. The extendable portion 325 may further include a conductive pathway, such as a wire, that is electrically connected to the gloves 310 via the connector block 324, and may be electrically connected to the slicer 100 via the safety interlock 170. The conductive pathway may be extendable from and retractable into the connector block 324 by a spring return in the connector block 324. The spring return may be a viscus damped or constant force spring return to return the extendable portion 325 at a preset speed to prevent whipping while retracting. The electrical pathway and the spring return may enable the connector block 324 to extend and retract a specified distances towards and away from the safety interlock 170, when magnetically and conductively connected to the safety interlock 170, such that a user may move within a specified distance without a magnetic and conductive connection between the safety interlock 170 and the connector block 324 on the user being broken. The specified distance may be, for example, 3 inches. When the user moves beyond the specified distance, the magnetic and conductive connection is broken, and the extendable portion 325 of the connector block 324 may automatically retract. In another embodiment, the safety interlock 170 may be configured as a moving spring wound retractable block and include an extendable portion, like extendable portion 325. If a user wearing the gloves 310 touches the blade 110 while the glove system 350 is connected to the slicer 100, an electrical circuit between the components may be completed, and the control system may cause the blade 110 to stop in time so that the user is not severely injured and the slicer 100 is not damaged. A concept behind the conductive stop is to allow one to a discern a voltage that represents the glove coming into contact with the ground, in contrast to meat or wet environments.

The circuit across the two gloves 310 may represent a bio impedance and can indicate the presence of a worker to initiate calibration and proper operation. Insulators, such as a ground insulator, can be used to electrically isolate a drive mechanism, such as the shaft 130, from a body of the slicer 100. Accordingly, the blade 110 may be electrically detectable.

Alternatively or additionally, the gloves 310 may be used to cause the blade 110 to stop before the user touches the blade 110. For example, the gloves 310 may include metal such that the gloves 310 may be detected as a metal object in an entryway to the blade 110. That is, a metal detection system may detect the gloves 310 as a metal object in the entryway, thereby causing the blade 110 to beginning stopping and stop before a hand of the user is pulled into a mechanism, including the blade 110. By placing the metal detection system adjacent to an entry point to the blade 110, such as at the front of the blade 110 where product may be cut, and shielding the detector circuit from detecting metal in certain directions, the metal detection system may be configured to detect metal at the entry point and a detection threshold can be selected. The gloves 310 can also be loaded with metal to obtain a specified threshold for metal detection of the gloves 310 by the metal detection system. The fingertips of the gloves 310 can be proportionally loaded with metal material for detection. In view of the above, the gloves 310 may be both conductive, for detecting the gloves 310 when they touch the blade 110, and include metal, for detecting metal in the gloves 310 when they are near an entryway to the blade 110, intrinsically at the same time within a dual safety system of the slicer 100. Limits and thresholds of the safety system can be easily set and repeated. For example, the limits and thresholds for metal detection and conductive glove detection may be set in the control system 413 of the slicer 100.

With some metal detection sensors and systems, a slicer may not stop if the object being sensed is moving too fast. For example, a slicer may not stop due to a relatively long total processing time of the sensor or system. To solve this issue, a metal detector system of the present disclosure may be used. For example, a metal detector system 900 of the present disclosure may include a focused sensing field directed to the meat tunnel or entry point to the blade 110. The focused sensing field may be provided by using magnetic shielding in the metal detector system.

As illustrated in FIG. 9, the metal detector system 900 may include at least one detector 910. The detector may be of any type of metal detector known in the art. For example, the detector 910 may be of a technology using beat frequency oscillation (BFO), pulse induction (PI), or very low frequency (VLF). In an embodiment, the detectors 910 may be provided at one or more locations, including at the sides of and above the slicer body. The detectors 910 may be positioned at an entryway to the blade 110.

In an embodiment, the detector 910 may be configured to detect metal in a location by, for example, detecting a change in a magnetic field caused by the presence of metal in the location. The detector 910 may include an excitation coil 920 that produces a magnetic field when provided with an electric current, the magnetic field causing eddy currents to be induced in nearby metal, thereby causing the metal to also produce a magnetic field. The detector 910 may also include a metal detection coil 930 that detects a change in the magnetic field of an area caused when metal in the area is exposed to the magnetic field of the excitation coil 920. For example, the metal detection coil 930 may produce a corresponding voltage or other response based on the location of the metal with respect to the metal excitation coil 920 and the metal detection coil 930.

The detector 910 may include a detection controller 940, including at least one processor, that determines whether an output of the metal detection coil 930 corresponds with detection of the metal based on, for example, whether the output of the metal detection coil 930 to the detection controller is above a predetermined level. An amplifier 932 and a demodulator 934 may be used on an output side of the metal detection coil 930 to the detection controller 940. The detection controller 940 may output a metal detection result to a detection output 942, such as the controller 164 illustrated in FIG. 6. The detection controller 940 may be formed in or external to the detector 910. For example, when external, the detection controller 940 may be connected to a plurality of the detectors 910 to determine a metal detection result for each detector 910. The detection controller 940 may be integrated with or external to the metal detection system 900. The processor 412, described above with respect to FIG. 6, may function as the detection controller 940 to one or more detectors 910 from outside the metal detection system 900.

PWM drivers 944 may also be included in the detector 910 for generating a pulse in the excitation coil 920 or the metal detection coil 930, depending on the type of metal detection technology used. The detection controller 940 may control the PWM drivers 944. The detector controller 910 may also receive a signal for calibration tuning 946.

The metal detector system 900 may also include shielding material 960 that provides magnetic shielding to at least one of the detectors 910. For example, the excitation coil 920 and the metal detection coil 930 may be within a shielding profile of the shielding material 960. In an embodiment, the shielding material may be integrated into or around the slicer body 130, or at other locations of the slicer 100 where the detectors 910 are located. The shielding material may isolate a metal detection circuit of the detector 910 from metal within and around the slicer body 130, such that a detection area 950, as shown in FIG. 6, of the detector 910 is shaped. The detector 910 may be positioned and the shielding material 960 may be provided such that detector 910 detects the gloves 310 when the gloves 310 move to an entryway of the blade 110. The entryway of the blade 110 may be at an aperture of the slicer 100 to the blade 110.

In a safety system embodiment of the present disclosure that includes a metal detector, the processing and output time of the safety system may be around 0.014 seconds and the embodiment may have a buffered output in case a scan misses closing a relay to give a stop signal for stopping the slicer. The safety system may also detect if the metal detector is calibrated and, if the metal detector is faulted, will shut the slicer off when certain conditions are not met. The safety system may record all of the positive hard stops of the slicer and may be viewable to a supervisor or other qualified person.

Alternatively or additionally, the input signal to trigger an automatic-stop of the slicer 100 may be based on a visual cue. For example, the glove 310 may be a colored glove 320, as illustrated in FIG. 10. With reference to FIG. 10, a camera 180 may detect when the colored glove 320 enters into a safety zone 325 of a saw blade 328. Although the saw blade 328 is shown to be a band saw blade, the saw blade may alternatively be, for example, the blade 110 that is circular. A safety zone 325 may be, for example, a cutting path in a range of 2 inches or less in front of the blade. Alternatively, the safety zone 325 may be more than 2 inches from the front of the blade and may include any sized area around the saw blade. Surrounding the safety zone 235 may be a training zone 327. The colored glove 320 may be green so that it can be reliably distinguished from, for example, fat and veins in a meat product. However, the colored glove 320 may have any color that can be reliably distinguished from a product cut with the slicer blade.

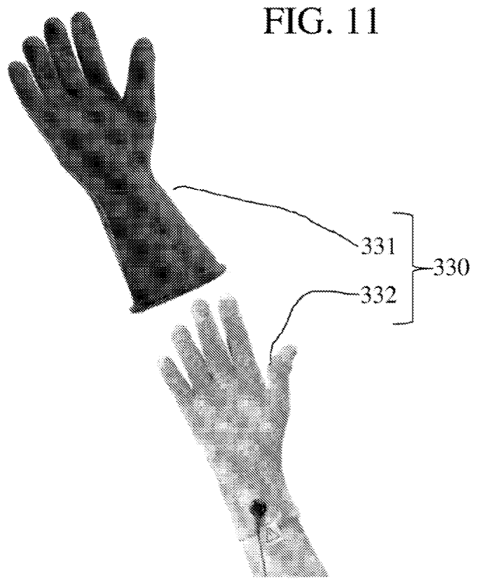

With reference to FIG. 11, an embodiment of a glove of a glove system that may be used in slicer systems is described.

To detect an operator while running product, and if a camera should not detect the operator or a colored glove when covered by the product, additional safety measures may be necessary.

Accordingly, as illustrated in FIG. 11, an embodiment of the disclosure may include a colored glove 331 and a conductive glove 332, together corresponding to glove 330, to enable proper connections and insulation, wherein the conductive glove 332 is to be provided under the colored glove 331. Alternatively, the conductive glove 332 and colored glove 331 may be an inner layer and an outer layer of a single glove, respectively. The conductive glove 332 may include metal for metal detection. Hereinafter, the combination of the conductive glove and the color glove will be referred to as the glove 330. A user may wear the glove 330 on each hand when operating the slicer 100. Using glove material that are suitable in the electronics and semiconductor industry may provide proper conductivity in the gloves 330. The glove 330 may be used in the glove system 350.

A glove during initial tests had an ohm reading of 10 k ohms, which is around the same as a human hand. It was found that the voltage drop through this glove may be too significant and the machine may not sense it. For example, in an experiment, one sensing's fibers were burned out and would not sense any longer. Thus, in an embodiment of the disclosure, it is preferable that the glove 330 have an ohm reading across the glove 330 at 5 ohms or less. Also, it is preferable to be able to read a voltage in a glove system low enough that a human will not be harmed or feel anything when the glove 330 is conducting to a sensing unit. In order to do this, it may be preferable to have special low voltage inputs on the drive being used, the preferred drive sensing a voltage from 3.5 volts dc and up. This voltage is low enough that a human should not feel the voltage.

By using glove systems such as the ones described in FIGS. 8 and 10-11 with, for example, slicer 100, the slicer 100 may operate with the same ease as a standard saw in which all operators in plants are currently used to. Also, while FIG. 11 illustrates gloves 330 to be used in, for example, glove system 350, the glove system may alternatively use conductive gloves 332 without colored gloves 331, when visual detection of gloves is not used in a slicer safety system.

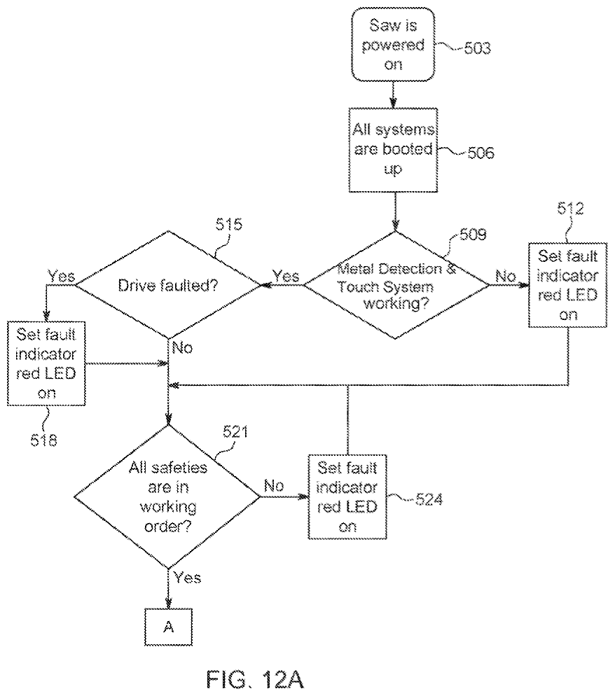

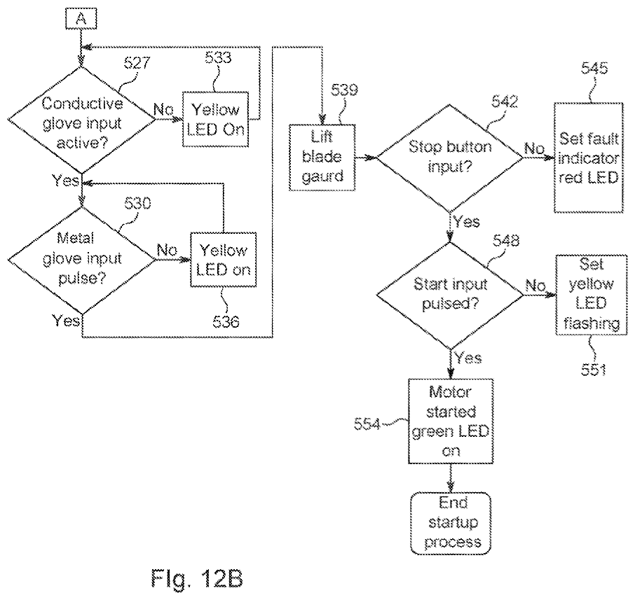

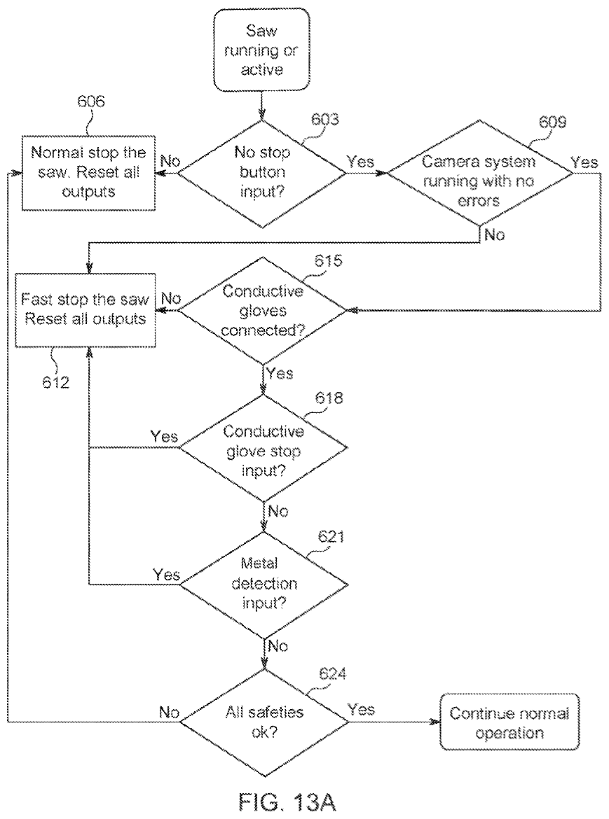

With reference to FIGS. 12A-B, an example startup process of the slicer system 400 is described. The startup process may be used, for example, when the slicer 100 is in a manual mode.

After the slicer 100 is powered on (step 503), all systems of the slicer 100 including the slicer monitor system 410 are booted up (step 506). Following, the processor 412 determines whether the metal detection system 900 and the conductive touch system of the gloves 330 is working (step 509). If at least one of the metal detection system 900 and the conductive touch system is determined to not be working, a fault indicator red LED may be set on (step 512) and the slicer monitor system 410 checks whether all safeties of the slicer 100 are determined to be working (step 521). If the metal detection system 900 and the conductive touch system is determined to be working, the slicer monitor system 410 determines whether a drive of the slicer 100 is faulted (step 515). If the slicer system includes a camera system with camera 180 and colored gloves, the slicer system 400 may also check whether camera system is determined to be working in step 509, and may also determine whether a drive of the camera system is faulted in step 515.

If a drive of the slicer 100 is determined faulted, a fault indicator red LED is set on (step 518), and the slicer monitor system 410 checks whether all safeties of the slicer 100 are determined working (step 521). If no drives are determined faulted, the slicer system 410 simply checks whether all safeties of the slicer 100 are determined to be working (step 521).

If the slicer monitor system 410 determines that not all safeties of the slicer 100 are working, the fault indicator red LED is turned on, if not already on, (step 524) and the process loops until all safeties of the slicer 100 are determined to be working (step 521).

As illustrated in FIG. 12B, once all the safeties are determined working, the slicer monitor system 410 determines whether the conductive and metal detection aspects of the gloves 332 are detected (steps 527 and 530, respectively). For example, the impedance & user ID monitor 419 may detect whether a signal is outputted from the glove system 350. Also, the processor 412 may detect whether one of the gloves 332 is detected by metal detection system 900. If one of the conductive and metal detection aspects of the gloves 330 is not detected, a yellow LED is lit (steps 533 and 536, respectively) and the process loops until the aspects are detected. Although not shown in FIG. 12B, the slicer monitor system 410 may also detect, with the processor 412, whether camera image data includes at least one of the colored gloves 331 when the slicer system includes colored gloves 331 and a camera system with camera 180. Similarly, if at least one of the colored gloves 331 is not detected, a yellow LED may be lit and the process loops until at least one of the colored gloves 331 is detected.

Once the conductive and metal detection aspects of the conductive gloves 332 (and, in some cases, the presence of the colored gloves 331) are detected, the guard 150 may be lifted (step 539), and the slicer monitor system 410 determines whether a stop button of the manual controls 426 is working (step 542). If no stop button input is received by the control system 413, the fault indicator red LED is turned on (step 545). If a stop button input is received, the slicer monitor system 410 then determines whether an input is received by the control system 413 from a start button of the manual controls 426 (step 548).

As long as no input from the start button is received, the yellow led is turned to flashing, thereby signaling the slicer 100 is idol (step 551). Once an input from the start button is received, the control system 413 controls the blade motor controller 415 to turn on the blade motor 122, and a green LED is turned on (step 554). Following, the startup process is ended.

The above-mentioned red, yellow, and green LEDs are not limited to their respective colors and may be any color. Further, the status indicators may be formed to include the above-mentioned LEDs.

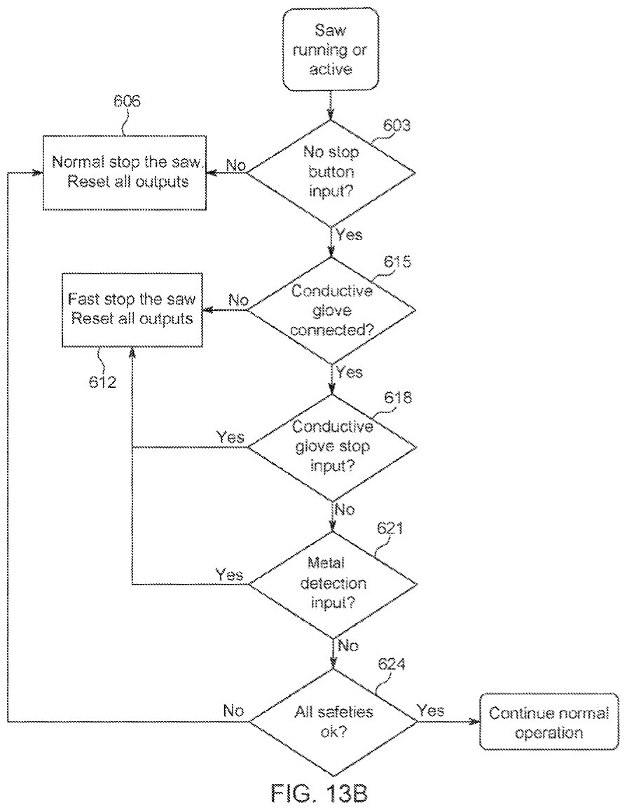

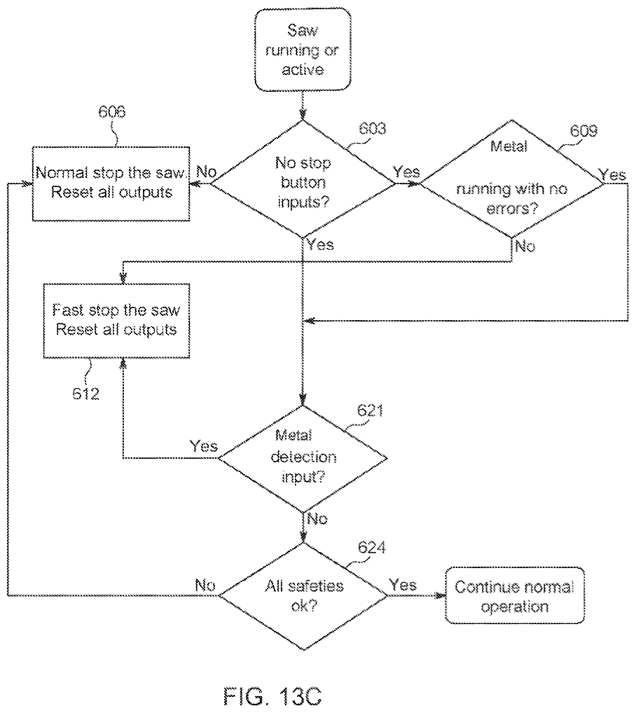

With reference to FIGS. 13A-C, example operations of a manual mode of the slicer system 400 after the slicer 100 is started is described.

With reference to FIG. 13A, the slicer monitor system 410 checks whether an input from the stop button is received by the control system 413 (step 603). If a stop button input is received, the slicer monitor system 410 causes a normal stop of the slicer 100 and all outputs are reset (step 606). If no stop button input is received, the processor 412 determines whether the metal detection system 900 is working with no errors (step 609). Although not shown in FIG. 13A, the processor 412 may alternatively or additionally determine at this time whether the camera system including the camera 180 is working with no errors when included in the slicer system 400.

If the metal detection system 900 (or the camera system, in certain cases) is determined to not be working due to errors, the slicer monitor system 410 causes a fast stop of the slicer 100 and all outputs are reset (step 612). If the metal detection system 900 (and the camera system, in certain cases) is determined to be working with no errors, the slicer monitor system 410 determines whether the conductive gloves 332 are connected to the slicer monitor system 410 (step 615). For example, the impedance & user ID monitor 419 may detect whether a signal is outputted from the glove system 350.

If at least one of the conductive gloves 332 are determined to not be connected, the slicer monitor system 410 causes a fast stop of the slicer 100 and all outputs are reset (step 612). Otherwise, the slicer monitor system 410 determines whether a stop input is received by the impedance & user ID monitor 419 from the glove system 350 (step 618). For example, the glove system 350 may output a stop signal if one of the gloves 332 in the glove system 350 touches the blade 110.

If a stop input is received, the slicer monitor system 410 causes a fast stop of the slicer 100 and all outputs are reset (step 612). Otherwise, the slicer monitor system 410 determines whether a metal detection input is received by the processor 412 from the metal detection system 900 that indicates a stop condition (step 621). For example, the processor 412 may determine whether one of the gloves 332 enters within an entry way to the blade 110. Although not shown in FIG. 13A, the processor 412 may alternatively or additionally determine at this time whether a camera detection input is received by the processor 412 from the camera 180 that indicates a stop condition. For example, the processor 412 may determine whether one of the gloves 330 enters within the safety zone 325.

If the metal detection input (or the camera detection input, in some cases) is received, the slicer monitor system 410 causes a fast stop of the slicer 100 and all outputs are reset (step 612). Otherwise, the slicer monitor system 410 may determine whether all safeties of the slicer system 400 are OK (step 624).

If at least one of the safeties of the slicer system 400 is not OK, the slicer monitor system 410 causes a normal stop of the slicer 100 and all outputs are reset (step 606). Otherwise, normal operation continues. The slicer 100 may function normally until stopped with a shutoff such as, for example, pressing of a stop button or kicking of an emergency kick stop. When normal or fast stop occurs, the control system 413 controls the blade motor controller 415 to turn off the motor 133, and the guard 150 may be automatically lowered.

With reference to FIGS. 13B-C, alternative example operations of a manual mode of the slicer system 400 after the slicer 100 is started is described. As illustrated in FIG. 13B, the slicer monitor system 410 does not determine whether the metal detection system 900 and the camera system including the camera 180 is working with no errors. As illustrated in FIG. 13C, the slicer monitor system 410 does not check whether the conductive gloves 332 are connected to the slicer monitor system 410, and further does not check whether a stop input is received by the impedance & user ID monitor 419 from the glove system 350. Also, it is noted that FIG. 13A describes a particular order of steps 615, 618, and 621. However, steps 615, 618, and 621 may be in any order in an embodiment.

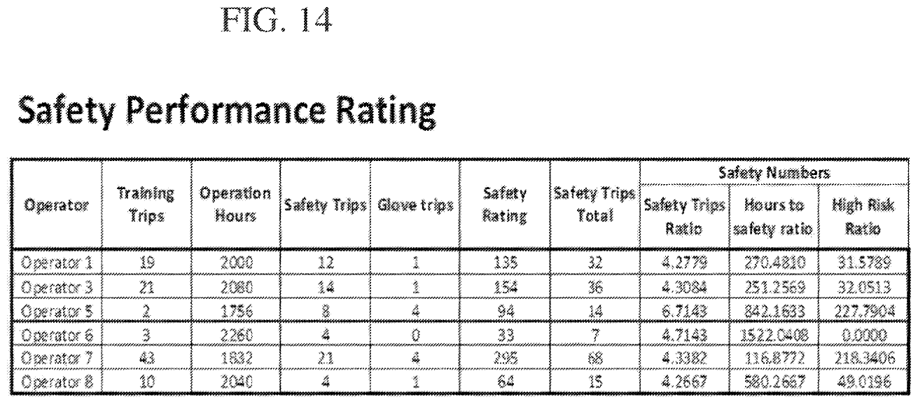

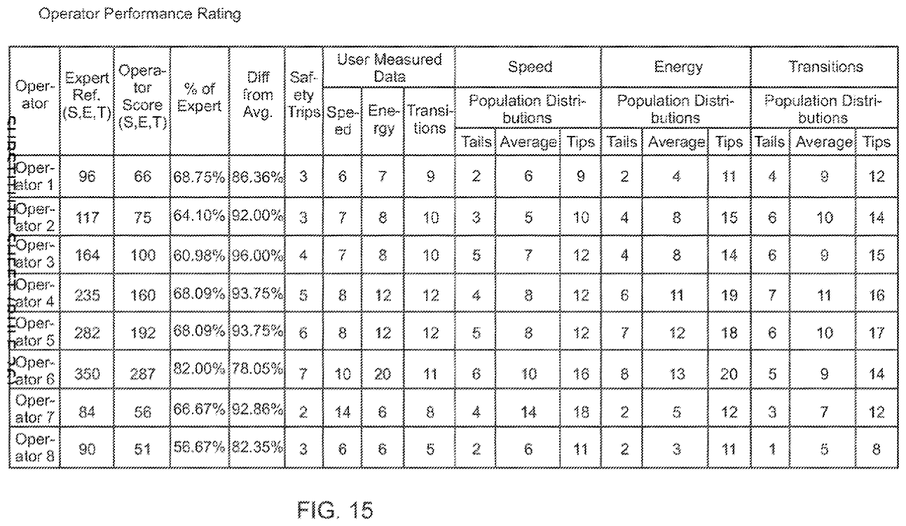

As the slicer 100 runs, the slicer system 400 may record operator statistics enabling tracking of performance, safety, and fatigue statistics. FIGS. 14-15 illustrate information of zones and performance that may be recorded by a slicer system for performance and safety rating purposes.

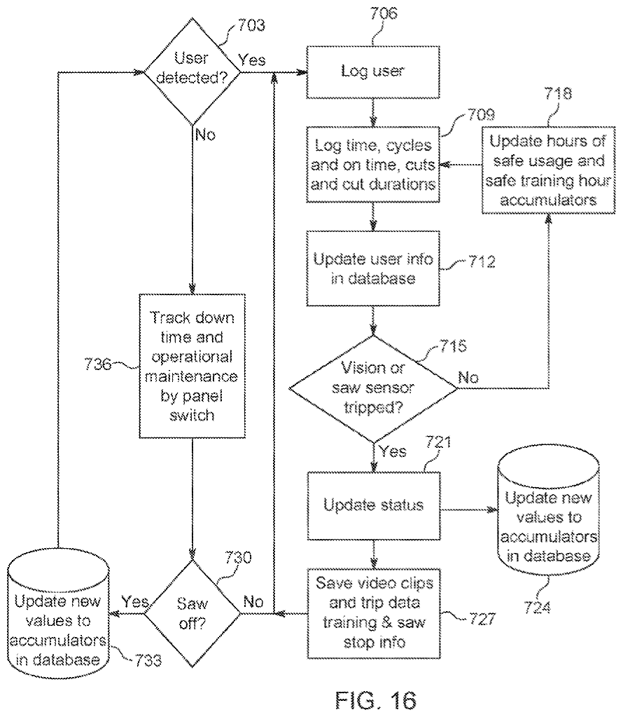

With reference to FIG. 16, a data tracking method of the slicer system 400 is described which performs identifying and storing user information for a user ID in conjunction with both training information and slicer stop information to build safety and performance statistics for the slicer monitor system 410 and the user.

The slicer monitor system 410 may determine whether a user of a glove system, such as glove system 350, is detected (step 703). If no user is detected, when the guard 150 is down and the system is idle, the control system 413 may accumulate the time the slicer 100 is not in use by time of day buckets for statistics (e.g. 10-11 am 10 minutes 22 seconds). The switches on the access panels and guards may be used to track maintenance and cleaning times and the accumulator's may also track these times for maintenance and cleaning by tracking various inputs on the access panels and guards (step 736). Following, the slicer monitor system 410 may determine whether the slicer 100 is off (step 730). If a user is detected, the user is logged (step 706); the time of logging, cycles and on time of the slicer system 400 during the user's operation of the slicer system 400, and cuts and cut durations of the slicer 100 by the user are logged (step 709); and such information of the user is updated in a database (step 712). The database may be provided in the memory of the slicer system 410 or externally in, for example, the cloud computing environment 820 or an externally provided memory device.

Following, the slicer monitor system 410 may determines whether a slicer sensor is tripped (step 715). For example, the slicer monitor system 410 may determine that a metal detection sensor is tripped when a metal detection is received by the processor 412 from the metal detection system 900 that indicates a stop condition. Alternatively or additionally, the slicer monitor system 410 may determine that a vision sensor is tripped when a camera detection input is received by the processor 412 from the camera 180 that indicates a stop condition. Further, the slicer monitor system 410 may determine a slicer sensor is tripped when a stop input is received by the impedance & user ID monitor 419 from the glove system 350.

If no slicer sensor is determined tripped, the slicer monitor system 410 may update hours of safe usage and safe training hour accumulators for the user (step 718). Following, the slicer monitor system 410 returns to step 709.

If at least one slicer sensor is determined tripped, the slicer monitor system 410 may update a status of the user in the database (step 721). For example, the slicer monitor system 410 may record information concerning the user's interactions with safety zone 325 and training zone 327 and information concerning the gloves 330 when they touch the blade 110 of the slicer 100. The slicer monitor system 410 may then store values of such information to accumulators within the database (step 724). The slicer monitor system 410 may also save video clips, vision or slicer sensor trip data, and slicer stop information within the memory of the slicer monitor system 410, or externally in, for example, the cloud computing environment 820 or an externally provided memory device (step 727).

Following, slicer monitor system 410 may determine whether the slicer 100 is off (step 730). If the slicer 100 is determined off, the slicer monitor system 410 may then store values of operation information to accumulators within the database (step 733) and return to step 703. If the slicer 100 is determined on, the slicer monitor system 410 returns to step 706.

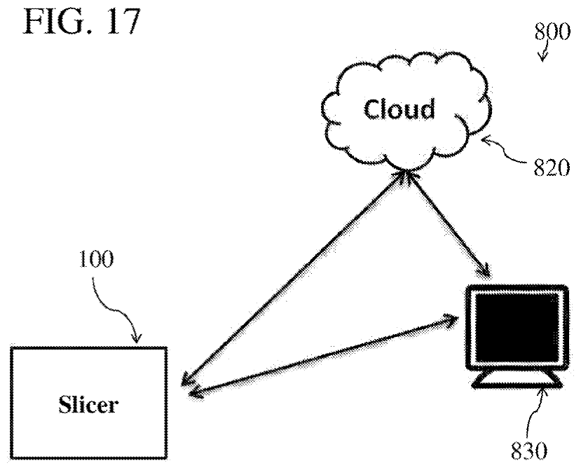

FIG. 17 illustrates an embodiment of a slicer system 800 that includes the slicer 100 that has connectivity to the cloud computing environment 820 and a display device 830.

Monitoring the performance statistics is very productive when the data is gathered from many sites. For example, site data can be compared and become valuable to a larger population of users. The safety and performance data as shown in FIG. 14 and FIG. 15 enable ranking and safety ratings for operators. Such data may be collected by the slicer system 800. The slicer 100 may be IP addressable and have Ethernet and WiFi capability. The slicer 100 may be controlled by an attached computer such as a CPU with memory, such as ROM or RAM having computer executable instructions written therein. Alternatively, the slicer 100 may be controlled by computing resources distributed in a cloud computing environment 820. The cloud based statistics and training enable an application on a display device 830, such as a PC, mobile device, or tablet, to show each manager the operator data for evaluations, training and propensity for safe operation. All together this enables a safer slicer, a safer environment, informed management, informed operators and overall method of safe operating ecosystem.

A network of processing equipment that communicates through a network together and track performance and assets running. Slicer blade hours of usage, replacement times and preventive maintenance for replaceable items and repair. Even cleaning times can be tracked. Pushing information up to the cloud for reporting and service models.

Additionally, because the entire drive system and braking system of an embodiment of the present disclosure may be electronic, a slicer may be restarted quickly after an automatic-stop is triggered. For example, after an automatic-stop event, an operator may need only to push a button to reset the system, confirm that safety systems are working by, for example, showing a glove to a camera or having it be detected by a metal detection system, and resume cutting. It is emphasized that due to the rapid stopping time, the blade of the slicer is not significantly damaged even though it may make physical contact with the conductive glove.

In order to prevent harm or damage, it is also beneficial to stop the blade as fast as possible. Prior systems would destroy the blade by mechanically crashing the blade into a nylon block. It is desirable to stop the blade without destroying the blade. In some embodiments of the present disclosures, a blade can be stopped within 0.1 seconds, without the blade being braked or controlled electrically. Instead, a lower wheel would be stopped. In some embodiments, this would cause the blade to travel around 8′ in blade length after the lower wheel was stopped. This allowed the blade to bite into the material and stop both wheels almost simultaneously without any damage or dulling to the blade. This also decreased the stopping time to under 0.05 second from 1200 RPM to 0 RPM. The braking force can be programmable and we can engage the energy required to stop the blade in less time as it relates to the ability to cut as determined by linear inches of blade rotation. We typically see this as less than 8″ of blade movement while touched, Ideally less than 4″ as the speed is decreasing from full speed to zero in that distance. Stopping time is a critical function of some system embodiments of the present disclosure. It is assumed that a stopping time of 0.1 seconds is plenty fast enough that an operator would not be injured. Some AC motors, permanent magnet motors, and servo motors, cannot achieve a machine stop time of under 0.1 seconds. However, after calculations and experimentation by the inventor, a solution was found with a specific type of motor and gear box. A motor of an embodiment of the present disclosure includes very low inertia, and a motor and gearbox of an embodiment are able to output enough torque to stop without being damaged in the process.

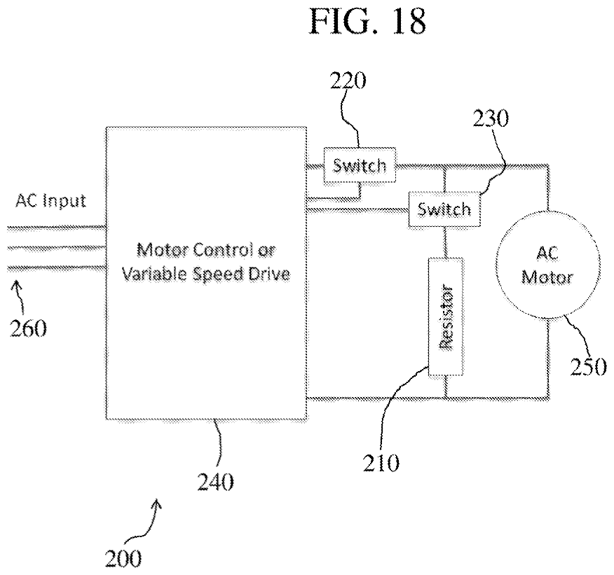

Blade brake time and travel time when stopping the blade 110 can be decreased by altering the system inertia by keeping the blade weight and shaft weight to a minimum. For example, by using a blade and shaft that are aluminum or include aluminum, the system accomplishes faster braking. Furthermore, eliminating the gear box and using a direct drive motor in an embodiment, the deli slicer may have reduced inertia and reduced stopping times. With reference to FIG. 18, a dynamic braking system 200 that may be included in the slicer 100 is described, in which brake performance can be achieved using blade 110 and the shaft 130. Dynamic breaking system 200 comprises, for example, an AC input 260, a motor control or variable speed drive 240, switches 220, 230, load resistor 210, and an AC motor 250, as the motor 133. The motor control or variable speed drive 240 receives power supplied from the AC input 260 and controls the AC motor 250. The brake may be an electrically engaged brake and clutch assembly may be incorporated into the motor assembly.

On nearly all gearboxes that can be standard ordered, the gearboxes are only offered with steel shafts. Since the slicer 100 may be direct driven from an output shaft, and the output shaft may be exposed to wash down and very caustic chemicals, the shaft and carrier assembly may be made with specialized components. For example, the shaft and carrier assembly may be made from proprietary stainless steel parts from Hollymatic to meet the inertial specifications.

Since the deli slicer may be direct driven from an output shaft on the motor, and the shaft is exposed to wash down and very caustic chemicals, the shaft and carrier assembly may be made with specialized components. For example, the shaft and carrier assembly may be made from proprietary stainless steel parts from Hollymatic to meet the inertial specifications.

The slicer 100 may use, in addition to dynamic breaking spring sets, magnetic braking for even lower braking times. The KEB magnetic braking system is a good example of an additional magnetic spring set clutch that can be engaged to act as an additional brake to help stop the slicer 100 faster. The pre-tensioned springs may be held back with a magnet that is energized while the blade motor 122 is in use. When the blade motor 122 is required to break the magnet, power is released and the springs brake the blade motor 122 in addition to the dynamic braking for maximum stopping times.

The deli slicer stop calculations and steps are listed below and requires no mechanical blade grabbing as other prior technologies have done to accomplish fast braking. It should be noted that operational up time and blade damage are concerns with mechanical grabbing of the blade.

Specifications for a dynamic breaking system 200 of an embodiment may be determined, for example, by the following slicer stop calculations and steps. By determining the specifications via the described slicer stop calculations and steps, fast breaking may be achieved without using mechanical blade grabbing that has been implemented in related art technologies in attempt to achieve fast breaking. Accordingly, the issues of reduced operational up time and increased blade damage that occur with mechanical blade grabbing of a slicer blade may be better avoided.

Step 1—Determine the Total Inertia
J_{T}=Total inertia reflected to the motor shaft, kilogram-meters², kg-m², or pound-feet², lb-ft²

Jₘ=motor inertia, kilogram-meters², kg-m², or pound-feet², lb-ft²

GR=The gear ratio for any gear between motor and load, dimensionless

J_{L}=load inertia, kilogram-meters², kg-m², or pound-feet², lb-ft² (1.0 lb-ft²=0.04214011 kg-m²)

Step 2—Calculate the Peak Braking Power

J_{T}=Total inertia reflected to the motor shaft, kg-m²

ω=rated angular rotational speed,

N=Rated motor speed, RPM

t₃-t₂=total time of deceleration from the rated speed to 0 speed, seconds

Pb=peak braking power, watts (1.0 HP=746 Watts)

Compare the peak braking power to that of the rated motor power, if the peak braking power is greater that 1.5 times that of the motor, then the deceleration time, (t3-t2), needs to be increased so that the drive does not go into current limit. Use 1.5 times because the drive can handle 150% current maximum for 3 seconds.

Peak power can be reduced by the losses of the motor and inverter.

Step 3—Calculating the Maximum Dynamic Brake Resistance Value

V_{d}=The value of DC Bus voltage that the chopper module regulates at and will equal 375 Vdc, 750 Vdc, or 937.5 Vdc

P_{b}=The peak braking power calculated in step 2

R_{db1}=The maximum allowable value for the dynamic brake resistor

The choice of the Dynamic Brake resistance value should be less than the value calculated in step 3. If the value is greater than the calculated value, the drive can trip on DC Bus overvoltage. Remember to account for resistor tolerances.

Step 4—Determine the Minimum Resistance

Each drive with an internal DB IGBT has a minimum resistance associated with it. If a resistance lower than the minimum value for a given drive is connected, the brake transistor will most likely be damaged.

Step 5—Choosing the Dynamic Brake Resistance Value

To avoid damage to this transistor and get the desired braking performance, select a resistor with a resistance between the maximum resistance calculated in step 3 and the minimum resistance of the selected chopper module.

Step 6—Estimating the Minimum Wattage requirements for the Dynamic Brake Resistor

It is assumed that the application exhibits a periodic function of acceleration and deceleration. If (t3-t2)=the time in seconds necessary for deceleration from rated speed to 0 speed, and t4 is the time in seconds before the process repeats itself, then the average duty cycle is (t3-t2)/t4. The power as a function of time is a linearly decreasing function from a value equal to the peak regenerative power to 0 after (t3-t2) seconds have elapsed. The average power regenerated over the interval of (t3-t2) seconds is Pb/2. The average power in watts regenerated over the period t4 is:

Pₐ, =Average dynamic brake resistor dissipation, in watts

t₃-t₂=Elapsed time to decelerate from rated speed to 0 speed, in seconds

t₄=Total cycle time or period of process, in seconds

P_{b}=Peak braking power, in watts

The Dynamic Brake Resistor power rating in watts that will be chosen should be equal to or greater than the value calculated in step 6.

Step 7—Calculate the requires Watt-Seconds (joules) for the resistor

In order the ensure that the resistors thermal capabilities are not violated, a calcualtion to determine the amount of energy dissipated into the resistor will be made. This will determine the amount joules the resistor must be able to absorb

P_{ws}=Required watt—seconds of the resistor

t₃-t₂=Elapsed time to decelerate from ω_{b} speed to ω₀ speed, seconds

P_{b}=Peak braking power, watts

Actual cutting and movement frictions and the addition of spring set magnetic braking combined with dynamic braking can reduce the actual slicer movement to just several inches to provide maximum safety.

Directional terms, such as “vertical,” “horizontal,” “top,” “bottom,” “upper,” “lower,” “inner,” “inwardly,” “outer” and “outwardly,” are used to assist in describing the disclosure based on the orientation of the embodiments shown in the illustrations. The use of directional terms should not be interpreted to limit the invention to any specific orientation(s).

It should be noted that although a few embodiments have been described, those skilled in the art will readily appreciate that many modifications are possible to embodiments of the present disclosure without materially departing from the novel teachings and advantages of the embodiments. Accordingly, all such modifications are intended to be included within the scope of the embodiments as shall be defined in the claims. Therefore, it is to be understood that the foregoing is illustrative of various embodiments and is not to be construed as limited to the specific example embodiments disclosed.

Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A slicer system comprising:
a slicer comprising:
a slicer blade configured for slicing a product;
a first motor configured to rotate the slicer blade;
an in-feed table configured to hold the product and move, while the product is sliced by the slicer blade;
an out-feed table configured to receive a sliced portion of the product, in response to the slicer blade slicing the product;
at least one second motor, each of the at least one second motor configured to move the out-feed table in at least one direction; and
at least one processor configured to cause the sliced portion of the product to be received on the out-feed table in a predetermined shape by controlling the at least one second motor to move the out-feed table while the slicer is slicing the product.

2. The slicer system of claim 1, wherein
the slicer further comprises:
a guard configured to cover the slicer blade; and
a third motor configured to move the guard between a first position in which the guard covers the slicer blade from an outside and a second position in which slicer blade is unguarded by the guard, wherein
the at least one processor is configured to control the third motor to move the guard.

3. The slicer system of claim 2, wherein
the at least one processor is configured to cause the guard to be in the first position while the product is sliced by the slicer blade.

4. The slicer system of claim 3, wherein
the at least one processor is configured to cause the guard to be in the second position in response to a slicing operation of the slicer blade being completed.

5. The slicer system of claim 1, wherein
the at least one processor is configured to receive a user command to fold the sliced portion of the product into the predetermined shape.

6. The slicer system of claim 3, wherein
the in-feed table is configured to be manually moved by a user,
the at least one processor is further configured to:
receive a user command to operate the slicer in a manual mode, and
keep, while the slicer is operating in the manual mode, the guard in the second position, while the user is manually moving the in-feed table to cut the product.

7. The slicer system of claim 6, further comprising:
a user-worn device comprising:
at least one magnet;
a conductive path; and
at least one processor configured to send a signal through the conductive path, wherein
the slicer comprises an interface including at least one magnet and a conductive path,
the at least one magnet of the interface being configured to magnetically engage with the at least one magnet of the user-worn device, such that the conductive path of the user-worn device is electrically connected to the conductive path of the slicer, and
the at least one processor of the slicer is configured to move the guard into the first position or the second position in response to receiving a specified signal from the conductive path of the user-worn device.

8. The slicer system of claim 7, wherein
the slicer is configured to move the guard into the second position in response to receiving the specified signal from the conductive path of the user-worn device.

9. The slicer system of claim 7, wherein
the user-worn device further comprises at least one processor configured to send the specified signal to the conductive path of the slicer, via the conductive path of the user-worn device.

10. The slicer system of claim 7, wherein
the at least one magnet of the user-worn device is configured to extend and retract from a body of the user-worn device while magnetically engaged with the at least one magnet of the interface of the slicer.

11. A method of controlling a slicer system including a slicer blade configured to slice a product, a motor configured to rotate the slicer blade, an in-feed table configured to hold the product and move, while the product is being sliced by the blade, an out-feed table configured to receive a sliced portion of the product in response to the slicer blade slicing the product, and at least one second motor configured to move the out-feed table in at least one direction, the method comprising:
slicing the product with the slicer blade; and
controlling, with at least one processor, a motor to move the out-feed table while the slicer is slicing the product such that the sliced portion of the product is received on the out-feed table in a predetermined shape.

12. The method of claim 11, wherein
the slicer further includes:
a guard configured to cover the slicer blade; and
a third motor configured to move the guard between a first position in which the guard covers the slicer blade from an outside and a second position in which slicer blade is unguarded by the guard, and
the method further comprising controlling, with the at least one processor, the third motor to move the guard.

13. The method of claim 12, wherein
the controlling the third motor to move the guard comprises controlling, with the at least one processor, the guard to be in the first position, and
the slicing the product comprises slicing the product while the guard is controlled to be in the first position.

14. The method of claim 13, wherein
the controlling the third motor to move the guard comprises controlling, with the at least one processor, the guard to be in the second position in response to a slicing operation of the slicer blade being completed.

15. The slicer system of claim 11, further comprising:
receiving, with the at least one processor, a user command to fold the sliced portion of the product into the predetermined shape.

16. The slicer system of claim 13, further comprising:
receiving, with the at least one processor, a user command to operate the slicer in a manual mode; and
controlling, with the at least one processor, the guard to be moved into the second position in response to receiving the user command, and
manually slicing the product with the slicer blade.

17. The method of claim 16, further comprising:
connecting a conductive path of a user-worn device to a conductive path of the interface of the slicer by magnetically engaging at least one magnet of the user-worn device to at least one magnet of the interface of the slicer; and
controlling, with the at least one processor, the guard to move into the first position or the second position in response to receiving a specified signal from the conductive path of the user-worn device.

18. The method of claim 17, wherein
the guard is moved into the second position in response to receiving the specified signal from the conductive path of the user-worn device.

19. The method of claim 17, further comprising:
sending the specified signal, by at least one processor of the user-worn device, to the conductive path of the slicer, via the conductive path of the user-worn device.

20. The method of claim 17, wherein
the at least one magnet of the user-worn device is configured to extend and retract from a body of the user-worn device while magnetically engaged with the at least one magnet of the interface of the slicer.
